(19) United States
(12) Patent Application Publication
(10) Pub. No.: US 2014/0180735 A1
(43) Pub. Date: Jun. 26, 2014

(54) METHOD AND ARRANGEMENT FOR PROVIDING INDIVIDUAL TRAVEL INFORMATION IN PASSENGER TRANSPORTATION SYSTEMS

(71) Applicants: Timo Holm, Nuernberg (DE); Florian Steinmann, Nuernberg (DE)

(72) Inventors: Timo Holm, Nuernberg (DE); Florian Steinmann, Nuernberg (DE)

(73) Assignee: SIEMENS AKTIENGESELLSCHAFT, MUENCHEN (DE)

(21) Appl. No.: 14/234,043

(22) PCT Filed: Jul. 10, 2012
(86) PCT No.: PCT/EP2012/063488

§ 371 Date: Jan. 21, 2014

(30) Foreign Application Priority Data
Jul. 18, 2011 (DE) 102011079328.3

(51) Int. Cl. G06Q 10/02

(52) U.S. Cl. CPC G06Q 10/02
USPC 705/5

(57) ABSTRACT

A method and a configuration provide individual travel information in people transportation systems on a mobile appliance associated with a passenger. Passenger-related travel data are provided to the mobile appliance. A data link is set up between the mobile appliance and a first information system in the people transportation system. Current travel information for the passenger-related travel data is output on the mobile appliance of the passenger, with the output of the current travel information of the passenger-related travel data on the mobile appliance of the passenger advantageously being effected preemptively (i.e. in superseding fashion) in respect of further processes taking place on the mobile appliance.

The present invention relates to a method and an arrangement for providing individual travel information in passenger transportation systems on a mobile device of a passenger.

In passenger transportation systems (e.g. trains, subways), the passenger must decide himself when it is necessary to leave or to change trains. For this purpose, he needs to know what intermediate destinations there are on this trip and what corresponding arrival times (itinerary) there are. At present, this process is supported by passenger information systems in the form of visual displays or audible announcements by the accompanying personnel. However, the passenger is obliged to correlate this information with his itinerary. Due to the ever increasing significance gained by electronic media, entertainment and communication, it becomes more and more difficult for the passenger to notice these announcements because, e.g. he is reading an E-book and listening to music or watching a film. In this context, watching the clock continuously is a necessary annoyance to the passenger. In addition, the increasing globalization ensures that the proportion of international travelers, who cannot understand the above-mentioned passenger information, is increasing. Furthermore, it is often the case that audible announcements are also incomprehensible to a native speaker because of the noise of the loudspeaker or because of the noise level of the accompanying passengers.

It is the object of the present invention to provide a method and an arrangement which, in correlation with an itinerary of a passenger, provide for the passenger, individually passenger-related and current travel information.

The object is achieved by a method for providing individual travel information in passenger transportation systems on a mobile device of a passenger, comprising the following steps:

a) Providing passenger-related travel data on a mobile device of the passenger;

b) Establishing a data link between the mobile device and a first information system of the passenger transportation system;

c) Outputting current travel information with respect to the passenger-related travel data on the mobile device of the passenger.

One advantage of the invention lies in relieving the passenger of the polling and correlating of the travel information for deriving a disembarkation decision. The passenger receives an interrupt when there is a change which has an effect on his itinerary, e.g. a timely notification that a transfer or disembarkation is required. For this purpose, a link is established between the information system of the transportation means and the appliance used by the passenger, e.g. tablet PC, E-book reader, mp3 player, mobile telephone (called appliance or mobile device in brief in the text which follows). Supported by this link, logic makes the disembarkation decision and informs the passenger in time. The passenger is thus dynamic about changes or travel events. Examples of possible features are:
Display of the remaining traveling time to disembarkation/transfer,
Representation of messages in any language selectable by the user, Wake-up function with dynamically variable wake-up time, i.e. adapted to the respective status, e.g. taking into consideration delays.

The passenger is relieved by the fact that he does not need to observe any announcements and displays. The passenger can devote himself, unstressed, e.g. to reading a book.

A first advantageous embodiment of the invention lies in that step a) “providing passenger-related travel data on a mobile device of the passenger” is effected by an eTicket of an eTicket-issuing system. As a result, the passenger-related travel data do not need to be input laboriously manually and prone to errors by the passengers on a mobile device. The passenger-related travel data can be loaded onto the mobile device of the passenger, e.g. by a download from the eTicket-issuing system (e.g. internet server of a travel provider). However, it is also possible that a printout or screenshot of the eTicket carries a barcode or a QR code which represents the travel data (departure, transfer, arrival times, etc.) with respect to a booked trip in encrypted form. The passenger can photograph the codes by a camera integrated in the mobile device (e.g. Smartphone) and thus load them onto the mobile device. The advantage of using QR code as travel identifier consists in, among other things, that data in QR code are present redundantly and can still be decrypted even if the code has been destroyed up to 30%.

A further advantageous embodiment of the invention lies in that step a) “providing passenger-related travel data on a mobile device of the passenger” is effected by reading out data from a personal online account of the passenger. This can take place in a simple and secure manner, e.g. by a download from an internet account of the passenger (e.g. as a registered customer with a travel provider).

A further advantageous embodiment of the invention lies in that step b) “establishing a data link between the mobile device and a first information system of the passenger transportation system” is effected by a WLAN system of the passenger transportation system. WLAN systems are widely used today for Internet access in passenger transportation systems (e.g. trains).

A further advantageous embodiment of the invention lies in that step c) “outputting current travel information with respect to the passenger-related travel data on the mobile device of the passenger” is triggered by a software agent of the first information system. After the registration of the passenger with the mobile device in the first information system (e.g. an internal information system of the passenger transportation system) and transmission of the travel data to the first information system, an application (e.g. software program, software agent) is started on the information system which, on the basis of the individual travel data of the passenger and the current travel data of the passenger transportation system (e.g. delays, unplanned stops), outputs the information needed for the passenger at the correct time (e.g. 10 minutes before a transfer time) on the mobile device of the passenger. The passenger can be notified of the new travel information, e.g. by an acoustic or visual signal or by vibration of the mobile device. The passenger thus receives an interrupt and does not need to poll continuously (e.g. look for displays).

A further advantageous embodiment of the invention lies in the fact that step c) “outputting current travel information with respect to the passenger-related travel data on the mobile device of the passenger” is effected by an application of the mobile device. An application is a user program with a logic which, on the basis of the individual travel data of the passenger and the current travel data, provided by the first information system, of the passenger transportation system, outputs on the mobile device travel-related data if required (e.g. destination will be reached within 10 minutes). The application may be present in the mobile device, e.g. as a standard on delivery, or be loaded onto the terminal by a download from an application store (internet sales portal).

A further advantageous embodiment of the invention lies in the fact that the application is transmitted by the WLAN system of the passenger transportation system via a download from the first information system to the mobile device. This enables the passenger to load an application tailored to the corresponding passenger transportation system in each case, if required.

A further advantageous embodiment of the invention lies in the fact that the first information system of the passenger transportation system is located locally in the passenger transportation system, and wherein this first information system is supplied locally with travel information dedicated to the passenger transportation system in the passenger transportation system. This is done, e.g., by the accompanying personnel of the passenger transportation system who can input current changes (e.g. delays) or conditions (e.g. arrival time at a railroad station) directly into the first information system.

A further advantageous embodiment of the invention lies in the fact that the first information system of the passenger transportation system is located locally in the passenger transportation system, and wherein this first information system is supplied with travel information by a second information system which is located outside the passenger transportation system. The second information system can be, e.g., a higher-level disposition system which also takes into consideration other passenger transportation systems. By this means, it is also possible, e.g., to take into consideration the situations (states) of other passenger transportation systems (e.g. delays in connecting trains) in the application.

A further advantageous embodiment of the invention lies in the fact that step c) “outputting current travel information with respect to the passenger-related travel data on the mobile device of the passenger” is effected preemptively with respect to further processes running off the mobile device. The information about a change relating to current travel data or the occurrence or imminence of a travel event (e.g. arrival at the connecting station) has the highest priority for the passenger). Preemptively displacing a current process (e.g. a film or a music application) on the mobile device ensures that the passenger receives this travel information currently and in real time.

A further advantageous embodiment of the invention lies in the fact that the mobile device is a laptop, a notebook, a mobile telephone, a Smartphone, a tablet PC, an E-book reader, a personal digital assistant (PDA) or an mp3 player. The method is suited flexibly for all types of mobile devices.

The object is also achieved by a mobile device suitable for performing a method as claimed in one of claims 1 to 11. Nowadays, every passenger has mobile devices such as, e.g. Smartphone's. Especially frequent travelers are equipped with these. In principle, the method can thus be used virtually ubiquitously worldwide.

The object is also achieved by an arrangement for providing passenger-related travel information in passenger transportation systems on a mobile device of a passenger, the arrangement comprising:
a) a mobile device suitable for receiving and for outputting current travel data on an output medium of the mobile device;
b) a first information system of the passenger transportation system for providing current travel data on the mobile device;

Wherein the outputting of the travel data on the output medium of the mobile device is effected on the basis of a parameterization matching the passenger with regard to the travel data of the passenger. The arrangement comprises devices already in existence and can be easily integrated or retrofitted in passenger transportation systems.

A further advantageous embodiment of the invention lies in the fact that the arrangement comprises a second information system which is located outside the passenger transportation system and supplies the first information system with travel information. By this means, it is also possible to take into consideration, e.g. the situations (states) of other passenger transportation systems (e.g. delays in connecting trains) during the output.

An exemplary embodiment of the invention is shown in the drawing and will be explained in the text which follows. In the figures:

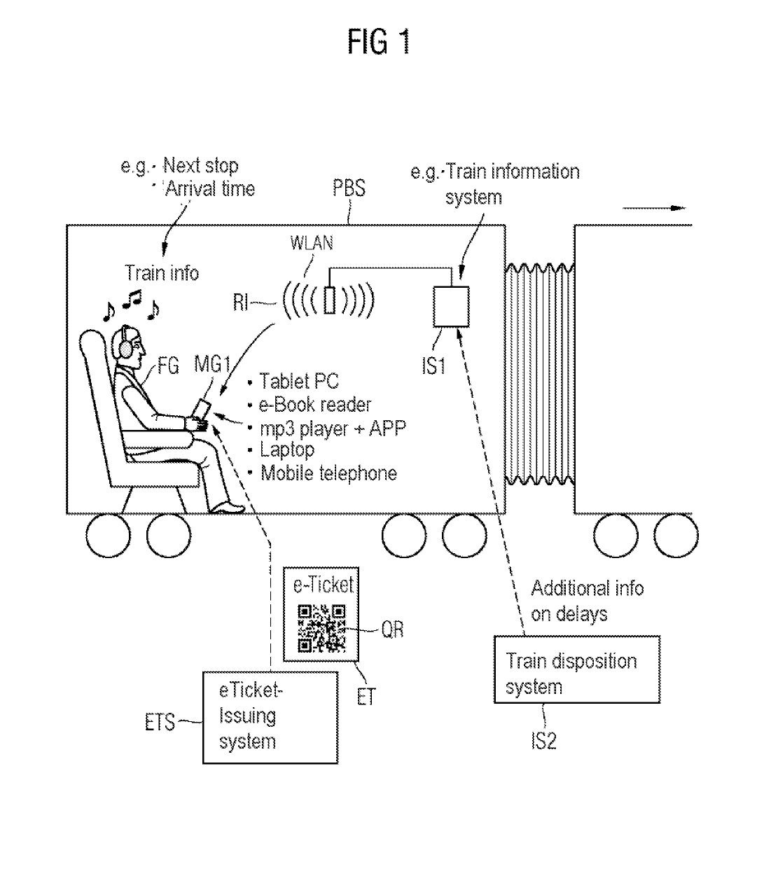

FIG. 1 shows an exemplary diagrammatic representation of the arrangement according to the invention,

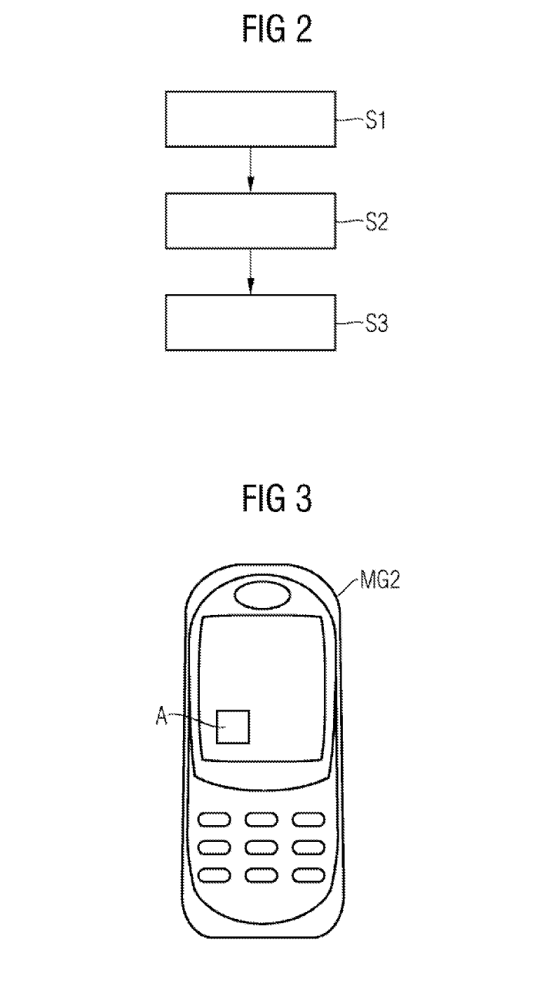

FIG. 2 shows an exemplary flowchart for the method according to the invention, and

FIG. 3 shows an exemplary mobile device suitable for use in the method according to the invention.

FIG. 1 shows an exemplary diagrammatic representation of the arrangement according to the invention in a passenger transportation system PBS (e.g. train). The passenger FG is provided with a mobile device MG1 (e.g. a laptop, a notebook, a mobile telephone, a Smartphone, a tablet PC, an E-book reader, a personal digital assistance (PDA) or an mp3 player. Passenger-related individual travel data can be loaded, e.g., by a download from an eTicket-issuing system ETS (e.g. Internet server of a travel provider) on the mobile device MG1 of the passenger FG. However, it is also possible that on a printout or screenshot of an eTicket ET, a barcode or a QR code is provided which represents the travel data (departure, transfer, arrival times, etc.) with respect to a booked trip in encrypted form. By means of a camera integrated in the mobile device MG1 (e.g. Smartphone), the passenger FG can photograph the codes and thus load them onto the mobile device MG1. Loading the travel data can also be effected, however, by a download from an Internet account of the passenger (e.g. as a registered customer with a travel provider) on the mobile device MG1. A first information system IS1 of the passenger transportation system PBS is located locally in the passenger transportation system PBS and supplies the mobile device MG1 with current travel information RI, e.g. via a radio-based WLAN link which exists in the passenger transportation system PBS. The passenger FG receives an interrupt on the mobile device MG1 when there is a change which affects his itinerary, e.g. a timely notification that changing of trains or disembarkation is required. The interrupt (i.e. a notification) is effected by an application (e.g. a software program, software agent, user program) which, based on the individual travel data of the passenger FG and the current travel data of the passenger transportation system PBS, outputs the information needed by the passenger FG (e.g. delays, unplanned stops) on the mobile device MG1 of the passenger FG at the correct time (e.g. 10 minutes before a transfer time). The passenger FG can be alerted, e.g. via an acoustic or optical signal or by vibration of the mobile device MG1 of the new travel information.

The application (A; FIG. 3) can run on a microprocessor of the first information system IS1 or on the mobile device MG1.

The arrangement can also have a second information system IS2. This can be, e.g., a higher-level dispositioning system which also takes into consideration other passenger transportation systems. By this means, it is also possible to take into consideration, e.g. the situations (states) of other passenger transportation systems (e.g. delays in connecting trains) in the application and thus in the information for the passenger FG. The second information system IS2 can also be coupled to information systems of other travel providers.

FIG. 2 shows an exemplary flowchart for the method according to the invention for providing individual travel information in passenger transportation systems on a mobile device (e.g. Smartphone) of a passenger, comprising the following steps:

S1) Providing passenger-related travel data on a mobile device of the passenger. Advantageously, this is effected by a download from an eTicket system or an Internet account of the passenger.

S2) Establishing a data link between the mobile device and a first information system of the passenger transportation system. This is done advantageously by a WLAN system in the passenger transportation system (e.g. train). The first information system is a local information system in the passenger transportation system (e.g. a train information system).

S3) Outputting current travel information with respect to the passenger-related travel data on the mobile device of the passenger. The outputting of the information is triggered by an application of the mobile device or of the first information system on the basis of the individual travel data of the passenger and the current situation-dependent travel data (e.g. taking into consideration delays) of the passenger transportation system. Advantageously, the outputting is effected preemptively, i.e. processes of the mobile device running currently are interrupted. The output can be audible or visual. The passenger can be advised of the presence of current travel information by audible, visual or vibration signals. The output and advice mode can be determined by being preset by the passenger on the mobile device.

By means of the method according to the invention and the arrangement according to the invention, respectively, the passenger is relieved of the polling and correlating of the travel information for deriving a disembarkation decision. For this purpose, a link is established between the information system (IS1; FIG. 1) of the transportation means (PBS; FIG. 1) and the appliance used by the passenger (FG; FIG. 1) (MG1; FIG. 1), e.g. tablet PC, E-book reader, mp3 player, mobile telephone. Supported by this link, logic in the form of a software program makes the disembarkation decision (i.e. the passenger is informed in time).

Possible features are:
display of the remaining travel time up to disembarkation/changing of trains (in any selectable language)
wake-up function with dynamically variable wake-up time, e.g. taking into consideration delays.

The bases for the disembarkation decision by the application (A; FIG. 3) are:
the information provided by the passenger transportation information system (PBS; FIG. 1):
   about stops and their arrival times, which change dynamically in accordance with the current travel situation (this may require communication with a higher-level disposition system (IS2; FIG. 1)).
   Unambiguous ticket numbers for which a passenger action (disembarking or changing trains) is pending. Identifier of the mobile device (MG1; FIG. 1) for which a passenger action (disembarking or changing trains) is pending.
Identifier of the mobile device (MG1; FIG. 1) for basic presence of the passenger in the transportation system (PBS; FIG. 1). This is read out by the first information system (IS1; FIG. 1) of the transportation means (PBS; FIG. 1).
Destination information of the passenger which can be transferred from an online ticket system (travel information) (ETS; FIG. 1) via an electronic ticket (ET; FIG. 1), can be read out from a personal online account of the passenger after registration or can be input manually on the mobile device (MG1; FIG. 1):
   input of destination and changing locations
   input of an unambiguous ticket number and interrogation of online ticket system, possibly further travel or passenger related data.

By means of said information, it is determined by means of a logic of an application, (App in brief) which is executed either as an agent in the first information system (IS1; FIG. 1) of the transportation means or on the mobile device (MG1; FIG. 1) itself when the passenger has to be signaled information about impending disembarkation or train-changing stations.

Possible signaling types are:
vibration, e.g. as a wake-up function during sleep
acoustic signaling (speech synthetization (in any language), e.g. during listening to music. Visual signaling, e.g. dialog during E-book-reading.

This information is provided to the passenger via his personal appliance (mobile device). The period between notification, signaling and arrival can be configured individually by the passenger. Furthermore, the signaling types can be configured individually by the passenger. Changes in the itinerary are thus output dynamically (i.e. adapted to the respective circumstances) and in real time on the mobile device of the passenger.

FIG. 3 shows an exemplary mobile device MG2 which is suitable for use in the method according to the invention. The mobile device MG2 can be, e.g., a Smartphone or a laptop. Outputting the current passenger-related information is specified by an application A of the mobile device MG2 and triggered on the basis of the individual travel data of the passenger and the current situation-dependent travel data (e.g. taking into consideration delays) of the passenger transportation system. The outputting is advantageously preemptive, i.e. processes of the mobile device running currently are interrupted. The output can be audible or visual. The passenger can be advised of the presence of current travel information by audible, visual or vibration signals. The output and advice mode can be determined by presetting on the mobile device MG2. The application A can for example be transferred to the mobile device MG2 by a download from the first information system IS1. The application A can be started, parameterized, interrupted (sleep mode) or ended by the passenger (FG; FIG. 1) by inputs on the mobile device. A method and arrangement for providing individual travel information in passenger transportation systems on a mobile device of a passenger, comprising the steps: a) providing passenger-related travel data on a mobile device of the passenger; b) providing a data link between the mobile device and a first information system of the passenger transportation system; and c) outputting current travel information with respect to the passenger-related travel data on the mobile device of the passenger, wherein advantageously the outputting of current travel information with respect to the passenger-related travel data on the mobile device of the passenger takes place preemptively (i.e. in a displacing manner) with respect to other processes running off the mobile device. The passenger is thus informed currently about his itinerary by the existing technical equipment during his journey. Changes in the itinerary are output dynamically and adapted in real time on the mobile device of the passenger.

### REFERENCE SYMBOLS

RI Travel information

PBS Passenger transportation system

ET eTicket

ETS eTicket-issuing system

QR QR code

IS1, IS2 Information system

FG Passenger

MG1, MG2 Mobile device

A Application

WLAN WLAN system

S1-S3 Method step

1-14. (canceled)

15. A method for providing individual travel information in a passenger transportation system on a mobile device of a passenger, which comprises the steps of:
a) providing passenger-related travel data on the mobile device of the passenger;
b) establishing a data link between the mobile device and a first information system of the passenger transportation system; and
c) outputting current travel information with respect to the passenger-related travel data on the mobile device of the passenger.

16. The method according to claim 15, which further comprises performing the step a) by means of an eTicket of an eTicket-issuing system.

17. The method according to claim 15, which further comprises performing the step a) by reading out data from a personal online account of the passenger.

18. The method according to claim 15, which further comprises performing the step b) via a WLAN system of the passenger transportation system.

19. The method according to claim 15, which further comprises triggering a performance of the step c) via a software agent of the first information system.

20. The method according to claim 15, which further comprises performing the step c) via an application of the mobile device.

21. The method according to claim 20, which further comprises transmitting the application by a WLAN system of the passenger transportation system via a download from the first information system to the mobile device.

22. The method according to claim 15, wherein the first information system of the passenger transportation system is disposed locally in the passenger transportation system, and the first information system is supplied locally with the travel information dedicated to the passenger transportation system in the passenger transportation system.

23. The method according to claim 15, wherein the first information system of the passenger transportation system is disposed locally in the passenger transportation system, and the first information system is supplied with the travel information by a second information system which is disposed outside the passenger transportation system.

24. The method according to claim 15, wherein the step c) is effected preemptively with respect to further processes running off the mobile device.

25. The method according to claim 15, which further comprises selecting the mobile device from the group consisting of a laptop, a notebook, a mobile telephone, a Smartphone, a tablet PC, an E-book reader, a personal digital assistant and an mp3 player.

26. A mobile device, comprising:
a processor;
a memory storing computer executable program instructions to be performed by said processor, said computer executable program instructions performing a method for providing individual travel information in a passenger transportation system on a mobile device of a passenger, which method comprises the steps of:
a) providing passenger-related travel data on the mobile device of the passenger;
b) establishing a data link between the mobile device and a first information system of the passenger transportation system; and
c) outputting current travel information with respect to the passenger-related travel data on the mobile device of the passenger.

27. A configuration for providing passenger-related travel information in passenger transportation systems, the configuration comprising:
a mobile device for use by a passenger and suitable for receiving and for outputting current travel data on an output medium of said mobile device; and
a first information system of the passenger transportation system for providing current travel data on said mobile device, an outputting of the current travel data on said output medium of said mobile device being effected on a basis of a parameterization matching the passenger with regard to the current travel data of the passenger.

28. The configuration according to claim 27, further comprising a second information system disposed outside the passenger transportation system and supplying said first information system with the travel information.
